(19) United States
(12) Patent Application Publication
(10) Pub. No.: US 2010/0229299 A1
(43) Pub. Date: Sep. 16, 2010

(54) Patient Lifting Apparatus

(76) Inventor: Adam Thomas Lear, Salisbury East (AU)

Correspondence Address: AKERMAN SENTERFITT, P.O. BOX 3188, WEST PALM BEACH, FL, 33402-3188, US

(21) Appl. No.: 12/679,593

(22) PCT Filed: Sep. 24, 2008
(86) PCT No.: PCT/AU2008/001411

§ 371 Date: May 28, 2010

(30) Foreign Application Priority Data
Sep. 24, 2007 (AU) 2007905193

(51) Int. Cl. A61G 7/10

(52) U.S. Cl. 5/89.1

(57) ABSTRACT

A patient lifting apparatus that includes a front and rear independently controlled cable lowering means so that a patient sitting in a sling suspended from the cables can be assisted out of the sling, or into the sling depending on the situation. This provides great, and safer, control of patient movement that otherwise provided.

### FIELD OF THE INVENTION

The field of the invention relates to apparatus and equipment for lifting and in particular, the lifting of human patients.

### DESCRIPTION OF THE PRIOR ART

In hospitals and patient care facilities there is often a need for equipment designed to lift a person from one position to another full stop for example, it is often the case that a patient who is incapacitated may need to be lifted from their bed, in a lying down position, up and into a chair.

Typically this is often itchy by the use of two and sometimes three orderlies or hospital staff specifically trained to efficiently and safely lift patients. Each staff member has a specific position relative to the patient and it is essential that each member coordinates their lifting efforts with the other staff member to affect a successful lift and transfer.

However, is quite common for hospital staff to become injured during such lifting efforts due to the weight of the patient as well as the lack of control in actually lifting and moving the patient, which results in muscle strain and other associated injuries. Quite often the patient may also be inadvertently injured if dropped or bumped against furniture during the uncontrolled transition.

### OBJECT OF THE INVENTION

It is an object of the present invention to provide a patient lifting apparatus having increased stability.

It is a further object of the present invention to provide a patient lifting apparatus having increased lifting capability compared to patient lifting apparatus presently available.

It is a further object of the present invention to provide a patient lifting apparatus capable of controlling the vertical position of the patient support sling.

It is an object of the present invention to overcome, or at least substantially ameliorate, the disadvantages and shortcomings of the prior art.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a patient lifting apparatus including a main frame, a base support section, an upper section having a first and second spaced apart upper members, each upper member including a front and rear spaced apart pulley to provide a front and rear pair of pulleys, each pulley having a cable running there through and each cable terminating in its own sling attachment point to operatively connect to a patient support sling at one end, and each front and rear cable pair connected separately to a pair of cable controlling means such that in use a pair of cables is able to be extended or retracted by cable controlling means as required by an operator so as to control the raising or lowering of the patient support sling.

The sling thus has a front end and a rear end operatively connected to the front and rear cable pair.

In preference each pair of pair of pulleys is located within the first and second spaced apart upper members of the upper section.

In preference, the cable controlling means are capable of being independently controlled on from the other so as to effect an independent raising or lowering of a front or rear section of the patient support sling.

In preference, the base section includes ground-engaging wheels to allow the apparatus to be moved.

In preference, the cable controlling means is at least one winch.

In preference, the upper and lower sections are “U”-shaped.

A method of operating a patient lifting apparatus, the patient lifting apparatus including a main frame, a base support section, an upper section having a first and second spaced apart upper members, each upper member including a front and rear spaced apart pulley to provide a front and rear pair of pulleys, each pulley having a cable running there through, to form a front and rear set of cables, and each cable terminating in its own sling attachment point to operatively connect to a patient support sling, and each front and rear cable pair connected separately to a pair of cable controlling means: so that by activation of the pair of cable controlling means to effect a lowering or raising of the front and rear set of cables so that a front or rear section of the sling can be raised or lowered as required.

### BRIEF DESCRIPTION OF THE DRAWINGS

By way of example, an employment of the invention is described more fully the renown for with reference to the accompanying drawings, in which:

FIG. 1 is a front perspective view of the invention;

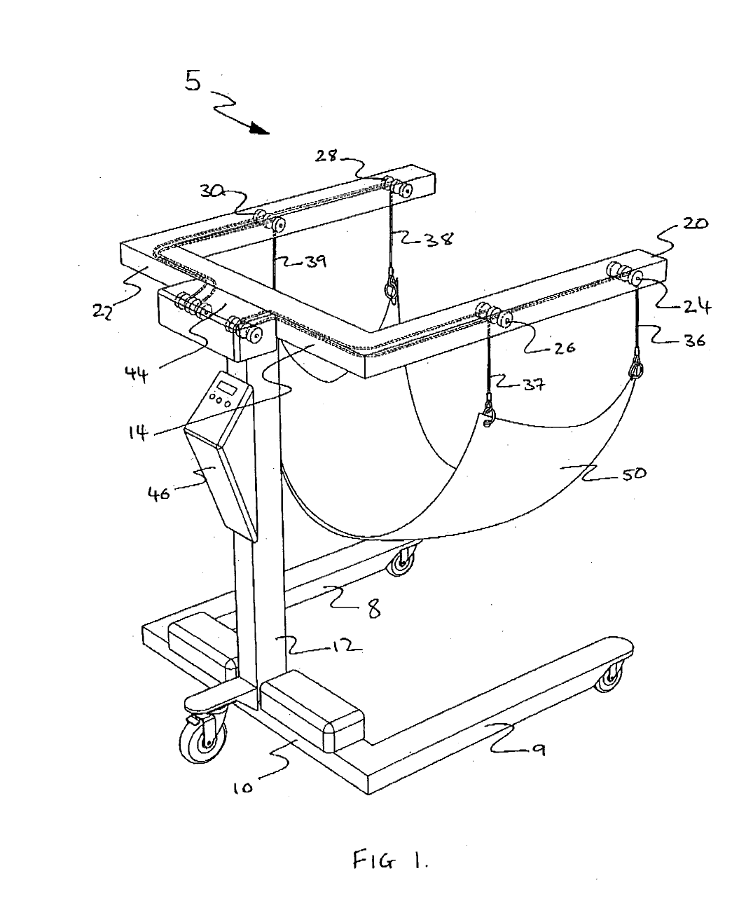

FIG. 2 is a front perspective view of the invention as shown in FIG. 1;

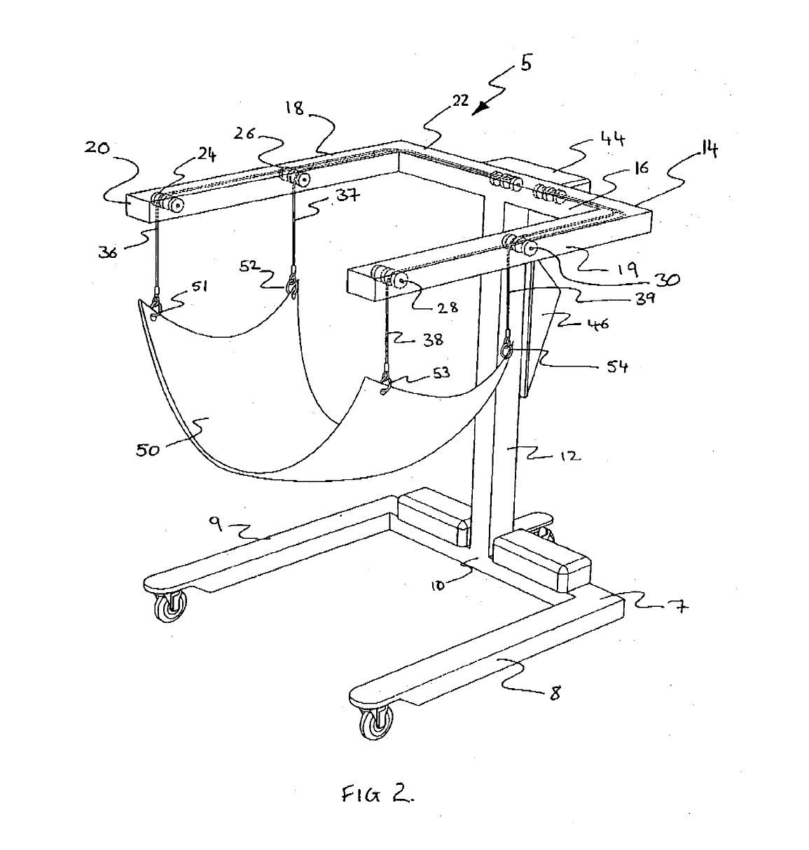

FIG. 3 is a side view of the invention with a patient positioned in the patent support sling

### DETAILED DESCRIPTION OF THE INVENTION

The patient lifting apparatus 5 includes a base support section 7 being in a generally “U”-shaped section, with parallel spaced apart legs 8 and 9 separated by the transverse member 10. Connected to the transverse member 10, approximately midway along its length, is the main upright support member 12 that in turn connects to an upper section 14.

The upper section 14 includes a transverse upper member 16 with first and second arms, 18 and 19 respectively, each arm having a front section 20 and rear section 22.

Each arm 18 and 19 has pulleys located within; for example, the first arm 18 has front pulley 24 and rear pulley 26 and the second arm 19 has a front pulley 28 and a rear pulley 30, such that there is effectively a front pair of pulleys 32 and a rear pair of pulleys 34. Each pulley is able to rotate about its axis although other pulley equivalent structures may be used to effect the same result and those skilled in the art would readily appreciate this.

Each pulley has a cable 36-39 that runs through or over it and the cables 36-39 are then attached to a cable controlling means, such as a winch or number of winches for controlling the release or uptake of the cable.

The cables 36-39 are arranged in pairs such that there is a front pair 40 of cables 36 and 38 and a rear pair 42 of cables 37 and 39. Each pair of cables 40 and 42 are then attached operatively their own winch so that front pair 40 is attached to one winch and rear pair 42 are attached to a separate winch.

Each of the winches are located on the main structure, such as in the winch housing 44, although the winches could be placed at other suitable for housing such devices. The person skilled in the art would be able to readily appreciate that the location can be varied. The winches are then connected to a controller 46, allowing an operator to control each pairing of cables 40 and 42 independently or in unison as required.

Each individual cable is attached to a patient support sling 50 at positions 51-54 in a manner that allows the sling 50 to be easily removed and replaced by an operator.

By being able to control each pairing of cables 40 and 42 is then possible to orientate the patient sling 50 by raising and lowering the appropriate pair of cable.

For example, it is possible to place the patient support sling 50 under a patient who is seated on a bed, then attach the sling 50 to the cables 36-39 and hoist the patient off the bed. The supported patient can then be moved away from the bed by simply controlling the movement of the patient lifter 5 as it is on wheels.

The patient may, for example, require then assistance in getting into a chair and so after positioning the patient directly over the chair the patient is then lowered slowly, with both pairs of cables being released in a controlled manner. At the appropriate time, just when the patients buttocks have come into contact with the seat of the chair, the operator can stop both cable pairs and elect to allow controlled release of the rear pair of cables 42, which then allows the patient to gently apply back pressure to the back of the chair, then slowly release the front pair 40 to allow the underside of the legs to, contact the seat of the chair. As can be understood, this very controlled manner of placing a patient is very desirable, especially with patient who are infirm.

Additionally, if a patient needs assistance to stand, rather then simply have the patient pull themselves up from their set, a patient in the support sling 50 can have their feet gently guided to the touch the ground and which point the patient may take hold of a support frame and begin to shift more of their weight onto their legs and the operator can then elect to activate the winch controlling the rear cable pair 42 to pull the rear of the sling upwards to assist the patient to stand. This can be combined with a very slow lowering of the front of the sling 50 by the front cable pair 40.

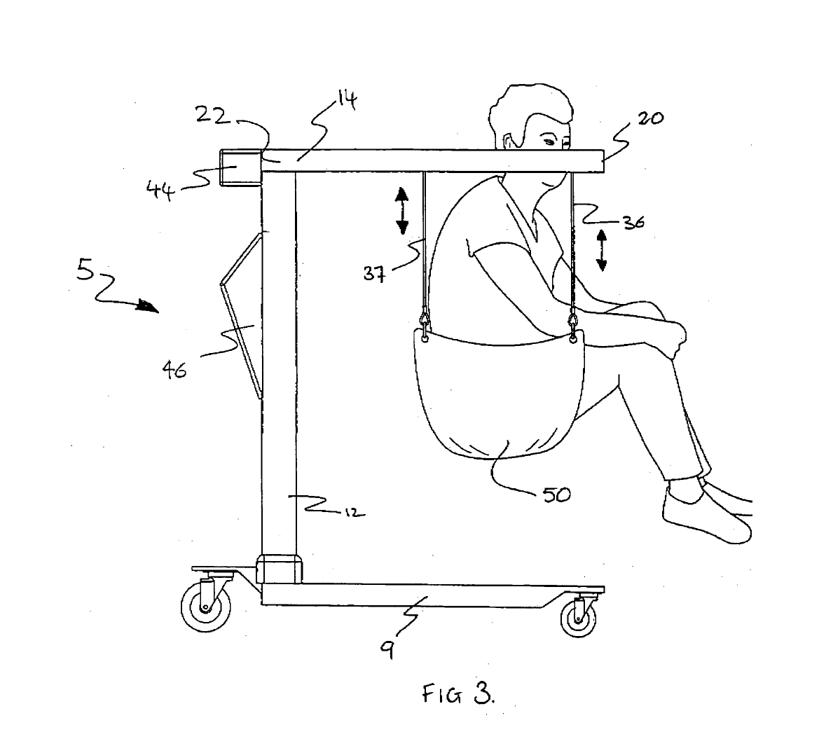

FIG. 3 shows a patient seated in the support sling 50 facing away from the apparatus 5, in which case the apparatus 5 would have approached the patient from behind. This particular position may be used if the patient is to be lifted from their seat and transferring them to a walking frame. In this way the apparatus 5 would not hinder the walking frame and allow the patient, once standing to freely move a away without having to necessarily move the apparatus 5.

If a patient were to be moved from one seated position to another, then it may be more convenient to have the patient facing in the other direction to that shown in FIG. 3, that is facing towards the apparatus 5 although this would be decided by the operator depending on the particular circumstance.

In addition to moving patients in the manner described, the sling 50 may be replaced with a stretcher, such as a patient stretcher or other suitable device for holding a patient in a horizontal position.

Such a stretcher would connect onto the cables 36-39 using convention attachment means and would orientate the stretcher substantially perpendicular to the first and second arms 18 and 19 respectively. In this manner then a patient lying prone on the stretcher could easily be raised and lowered from one bed to another, or the patient could be assisted of the stretcher and onto another bed, for example an operating table, by lowering the front pair of cables 40 to the point that one side of the stretcher parallel to the patient were touching the bed, then disengaging that side of the stretcher from the front cable pair 40 and gently raising the rear cable pair 42 in a controlled manner to assist movement of the patient from the stretcher onto the bed. This would be particularly useful if shifting patients who are overweight.

As can now be readily understood, the present invention then allows for a single patient lifting apparatus that is able to provide a multitude of patient lifting task that presently require many different specialized machines

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. A patient lifting apparatus including
a main frame,
a base support section,
an upper “U”-shaped section having a first and second spaced apart upper members,
each upper member including a front and rear spaced apart pulley to provide a front and rear pair of pulleys,
each pulley having a cable running there through and each cable terminating in its own sling attachment point to operatively connect to a patient support sling at one end, and
each front and rear cable pair connected separately to a pair of cable controlling means such that in use a pair of cables is able to be extended or retracted by cable controlling means as required by an operator so as to control the raising or lowering of the patient support sling.

2. The patient lifting apparatus of claim 1, wherein each pair of pulleys is located within the first and second spaced apart upper members of the upper members.

3. The patient lifting apparatus of claim 2, wherein the pair of cable controlling means are isolated from each other so that they operated independently to one another.

4. The patient lifting apparatus of claim 3, wherein the pair of cable controlling means is at least one winch.

5. A method of operating a patient lifting apparatus, the patient lifting apparatus including a main frame, a base support section, an upper “U”-shaped section having a first and second spaced apart upper members, each upper member including a front and rear spaced apart pulley to provide a front and rear pair of pulleys, each pulley having a cable running there through, to form a front and rear set of cables, and each cable terminating in its own sling attachment point to operatively connect to a patient support sling, and each front and rear cable pair connected separately to a pair of cable controlling means, the method including the step of:
activating the pair of cable controlling means to effect a lowering or raising of the front and rear set of cables so that a front or rear section of the sling can be raised or lowered as required.

6. The method of claim 5, wherein the rear pair of cables are raised higher than the front pair of cables so that a rear section of the sling is raised higher than a front section of the sling to assist the egress of a patient sitting in the sling.

7. (canceled)
